(19) United States
(12) Patent Application Publication
(10) Pub. No.: US 2024/0304005 A1
(43) Pub. Date: Sep. 12, 2024

(54) POLICE DASHCAM

(71) Applicant: Chi-Hsiu Chen, New Taipei City (TW)

(72) Inventor: Chi-Hsiu Chen, New Taipei City (TW)

(21) Appl. No.: 18/118,102

(22) Filed: Mar. 6, 2023

(51) Int. Cl. B60R 11/04; B60R 1/23; G06V 20/56; G06V 20/62

(52) U.S. Cl. CPC G06V 20/625; B60R 1/23; G06V 20/56; H04N 23/57; H04N 23/61; H04N 23/617

(57) ABSTRACT

The police dashcam includes a camera module having a camera and a control unit, a mobile communication module electrically connected to the control unit, a positioning module electrically connected to the control unit, and a display module electrically connected to the control unit. The control unit includes a license plate recognition unit utilizing artificial intelligence (AI). The license plate recognition unit can recognize the numbers on the license plates captured by the camera. The control unit searches a cloud database data-linked with the mobile communication module for the recognized numbers. If there is a match, a notification is shown on the display module.

### BACKGROUND OF THE INVENTION

### (a) Technical Field of the Invention

The present invention is generally related to dashcams, and more particular to a policing dashcam capable of license plate recognition through cloud databases.

### (b) Description of the Prior Art

To check a dubious license plate during patrol, an officer often has to enter the license plate number into a handheld device to query police databases. This act is more time-consuming and may alert suspects. These shortcomings may be overcome if the dashcam in the police vehicle is capable of license plate recognition.

### SUMMARY OF THE INVENTION

A major objective of the present invention is to provide a police dashcam capable of recognizing license plate numbers in the images captured by a camera and checking the license plate numbers against a cloud database.

To achieve the objective, the present invention teaches a police dashcam including a camera module having a camera and a control unit, a mobile communication module electrically connected to the control unit, a positioning module electrically connected to the control unit, and a display module electrically connected to the control unit. The control unit includes a license plate recognition unit utilizing artificial intelligence (AI).

The camera may be installed in the front of a vehicle, or there may be multiple cameras installed both on the front and rear sides of the vehicle. The police dashcam is data-linked with a cloud database through the mobile communication module in a wireless manner. The cloud database stores multiple license plate records. The license plate recognition unit can recognize the numbers on the license plates captured by the camera. The control unit searches the cloud database for the recognized numbers. If there is a match, a notification is shown on the display module.

The police dashcam may be installed on a motor vehicle or a motorcycle, where the police dashcam can draw power from the vehicle or motorcycle. The mobile communication module provides 4G or 5G mobile communications. The positioning module may be a global positioning system (GPS).

The display module may be a display screen, and may include a button for emergency use. For example, when some critical and urgent matter occurs, the button may be pressed and the control unit sends a distress signal, along with the current location detected by the positioning module through the mobile communication module.

The police dashcam may further include a wireless communication module electrically connected to the control unit providing Bluetooth or Wi-Fi communications with other mobile devices such as smart phones, smart watches, or tablet computers.

The police dashcam may further include a storage module electrically connected to the control unit storing the images captured by the camera.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the all upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing a police dashcam according to an embodiment of the present invention.

FIG. 2 is a flow diagram showing the operation of the police dashcam of FIG. 1.

FIG. 3 is a schematic diagram showing the appearance of the police dashcam of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

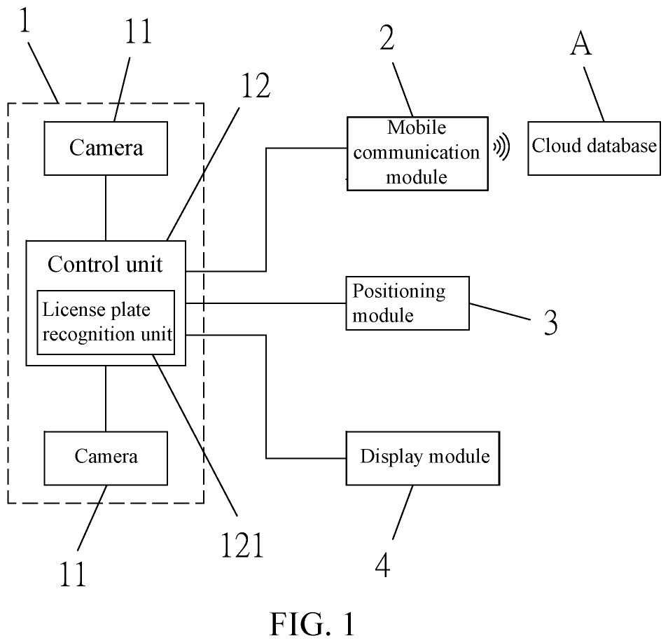

As shown in FIGS. 1 to 3, the police dashcam according to an embodiment of the present invention includes a camera module 1, a mobile communication module 2 electrically connected to the control unit 12, a positioning module 3 electrically connected to control unit 12, and a display module 4 electrically connected to control unit 12. The camera module 1 includes at least a camera 11 and a control unit 12. The control unit 12 includes license plate recognition unit 121 utilizing artificial intelligence (AI). The control unit 12 may be a digital video recorder (DVR).

The police dashcam may be installed on a motor vehicle or a motorcycle. The police dashcam can draw power from the vehicle or motorcycle. The camera 11 may be installed in the front of the vehicle or motorcycle. Their may be multiple cameras 11 installed both on the front and rear sides of the vehicle or motorcycle. The police dashcam is data-linked with a cloud database A through the mobile communication module 2 utilizing 4G or 5G mobile communication protocols. The positioning module may be a global positioning system (GPS). The license plate recognition unit 121 can recognize the numbers on the license plates captured by the camera 11. The control unit 12 searches the cloud database A for the recognized numbers. If their is a match, a notification is shown on the display module 4. The display module may be a display screen. The cloud database A stores multiple license plate records for, for example, those of stolen vehicles. Therefore, the police dashcam may automatically check license plates during the police's routine patrol without requiring the offices to stop their patrol and manually enter the license plate numbers through some handheld computers.

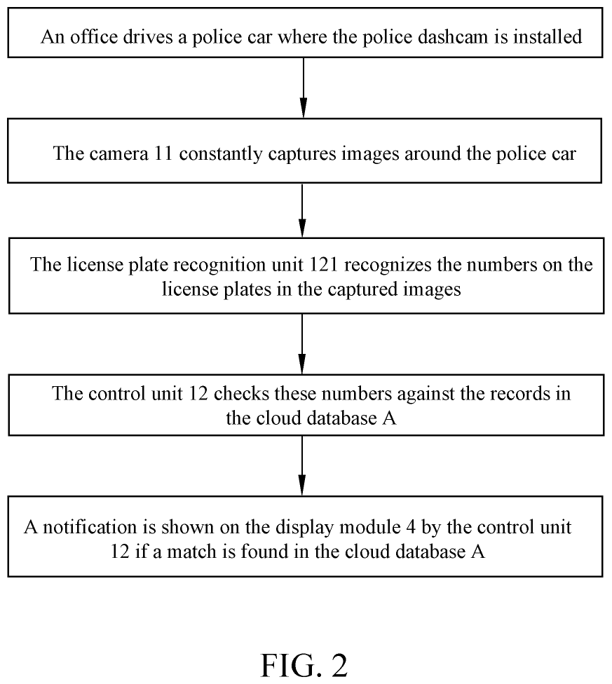

As shown in FIG. 2, the police dashcam operates as follows: (1) an office drives a police car where the police dashcam is installed; (2) the camera 11 constantly captures images around the police car; (3) the license plate recognition unit 121 recognizes the numbers on the license plates in the captured images; (4) the control unit 12 checks these numbers against the records in the cloud database A; and (5) a notification is shown on the display module 4 by the control unit 12 if a match is found in the cloud database A.

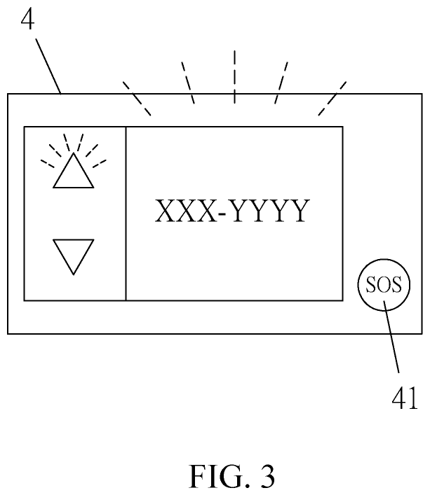

As shown in FIG. 3, when a match by the control unit 12 is detected, the license plate number may be shown in the display module 4 along with indicator light (e.g., red light). If there are multiple cameras 11 installed to the front and back of the vehicle, the display module 4 may further indicate by which camera 11 the license plate is captured. For example, if the license plate is captured by a front camera 11, the display module 4 may show an upward pointing triangle (as shown in FIG. 3); if it is captured by a rear camera 11, the display module 4 may show a downward pointing inverted triangle. Alternatively, the display module 4 may include multiple light indicators (not shown), and these light indicators may be triangle-shaped to indicate the camera 11 capturing the dubious license plate. If a large display module 4 is adopted, more information from the cloud database A can be displayed as well as the license plate number (e.g., whether the license plate belongs to a stolen vehicle).

In the present embodiment, the display module 4 further includes a button 41 for emergency use. For example, when some critical and urgent matter occurs, the button 41 may be pressed and the control unit 12 sends a distress signal, along with the current location detected by the positioning module 3 through the mobile communication module 2.

Whenever the cloud database A is updated or new license information added, the updates or new additions would be immediately reflected in the police dashcam's search.

The police dashcam may further include a wireless communication module (not shown) electrically connected to the control unit 12. The wireless communication module provides Bluetooth or Wi-Fi communications with other mobile devices such as smart phones, smart watches, or tablet computers. When the office is temporarily away from the vehicle and a dubious license plate is detected, the control unit 12 may send notification to the officer's smart phone or other mobile device. The control unit 12 also may receive distress signals firm other mobile devices (e.g., emergence notification firm the smart watch) and relay them through the mobile communication module 2, guaranteeing that urgent matters are not missed.

The police dashcam may further include a storage module (not shown) electrically connected to the control unit 12. The storage module may be a memory card storing the images captured by the camera 11.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A police dashcam, comprising:
a camera module comprising a camera and a control unit, where the control unit comprises a license plate recognition unit utilizing artificial intelligence (AI);
a mobile communication module electrically connected to the control unit;
a positioning module electrically connected to the control unit; and
a display module electrically connected to the control unit.

2. The police dashcam according to claim 1, wherein the mobile communication module provides 4G or 5G mobile communications.

3. The police dashcam according to claim 1, wherein the positioning module is a global positioning system (GPS).

4. The police dashcam according to claim 1, wherein the display module comprises a button for emergency use.

5. The police dashcam according to claim 1, further comprising a wireless communication module electrically connected to the control unit.

6. The police dashcam according to claim 5, wherein the wireless communication module provides Bluetooth or Wi-Fi communications.

7. The police dashcam according to claim 1, wherein the mobile communication module is data-linked with a cloud database in a wireless manner.

8. The police dashcam according to claim 1, further comprising a storage module electrically connected to the control unit.
